(19) United States
(12) Patent Application Publication
(10) Pub. No.: US 2010/0179044 A1
(43) Pub. Date: Jul. 15, 2010

(54) GLASS SUBSTRATE WITH REFRACTIVE INDEX GRADIENT AND MANUFACTURING PROCESS OF SAME

(75) Inventors: Julien Sellier, Paris (FR); Jerome Lalande, Champigny Sur Marne (FR); Rene Gy, Bondy (FR); Didier Le Couviour, Villemonble (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: SAINT- GOBAIN GLASS FRANCE, Courbevoie (FR)

(21) Appl. No.: 12/675,864

(22) PCT Filed: Sep. 3, 2008
(86) PCT No.: PCT/FR08/51567

§ 371 Date: Mar. 2, 2010

(30) Foreign Application Priority Data
Sep. 3, 2007 (FR) 0757327

(51) Int. Cl. C03C 14/00; C03C 21/00

(52) U.S. Cl. 501/32; 65/30.13

(57) ABSTRACT

The present invention relates to a glass substrate comprising at least one ion pattern obtained by a treatment for exchanging the alkali metal ions of the glass with silver ions originating from an outside source, said substrate being formed from a glass having a specific composition and said ion pattern having a variation in the refractive index greater than or equal to 0.03, a depth greater than or equal to 100 μm and a light transmission coefficient at 410 nm (TL₄₁₀) greater than or equal to 60%.

The present invention relates to the field of optical glass. It relates more precisely to glass substrates having at least one pattern with a refractive index gradient obtained by ion exchange.

The production of glass substrates having one or more patterns with a refractive index gradient incorporated into the glass has been the subject of many developments, the purpose of which is, in particular, to increase miniaturization and to better control the optical performance.

Glass substrates comprising such patterns are generally obtained by a process that combines an ion exchange (to obtain the refractive index gradient) and photolithography (to produce a mask on the surface of the glass in the shape of the pattern).

Ion exchange has been used for many years to produce patterns having a refractive index gradient in glass articles. It is a technique based on the ability that certain ions with different polarizabilities have, in particular alkali metal ions, to be able to exchange one for another and thus form an ion pattern. The ion exchange is carried out by treating the glass in a bath of molten salts of said ions at a high temperature, generally between 200 and 550° C., for a sufficient time to obtain the desired exchange level. An electric field may be applied to accelerate the ion-exchange rate.

It is well known that the sodium ions of a glass may be replaced with potassium, copper and/or lithium ions (see U.S. Pat. No. 3,524,737, U.S. Pat. No. 3,615,322 and U.S. Pat. No. 3,615,323). The variation of the refractive index in the final glass remains modest however.

It is also known to use thallium as a dopant ion that makes it possible to create zones that have a higher refractive index. Despite its toxic nature, thallium is the most widely used ion for carrying out ion exchange on glass.

Ion exchange with silver ions makes it possible to achieve a refractive index level comparable to that which is obtained with thallium while avoiding the associated toxicity risks. Nevertheless, it is observed that soda-lime-silicate glass develops an intense yellow coloration during the ion exchange caused by the appearance of colloids resulting from the reduction of Ag⁺ ions to Ag°, even when the amount of silver is low. Such coloration is not acceptable for optical glass.

Numerous solutions have been developed to overcome these drawbacks. For the most part, these solutions have consisted in proposing specific glass compositions suitable for treatment by ion exchange, especially compositions of the alkali-silicate glass type (U.S. Pat. No. 3,873,408 and U.S. Pat. No. 4,952,037) and of the borosilicate glass type (U.S. Pat. No. 3,880,630, U.S. Pat. No. 4,952,037, U.S. Pat. No. 5,958,810, U.S. Pat. No. 6,066,273, US-A-2001/0003724, US-A-2003/0161048 and US-A-2005/0137075).

A low-temperature ion-exchange process has also been proposed for limiting the yellowing of a soda-lime-silicate glass (EP-A-0 380 468).

The objective of the present invention is to provide a glass substrate capable of undergoing a treatment for exchanging the alkali metal ions of the glass with silver ions originating from an outside source, which makes it possible to form at least one ion pattern, said ion pattern having acceptable refractive index gradient and depth while having a yellow coloration that is as weak as possible.

More specifically, the invention aims to obtain a glass substrate that comprises at least one ion pattern having a variation in the refractive index relative to the glass located outside of the pattern greater than or equal to 0.03, a depth greater than or equal to 100 μm and a light transmission coefficient at 410 nm (TL₄₁₀) greater than or equal to 60%.

These objectives are achieved in accordance with the invention by choosing the substrate from substrates that have a specific glass composition. Said specific glass composition described below is that of the substrate before the ion exchange and it corresponds to the composition of the glass located outside of the silver pattern or patterns after the ion-exchange treatment.

In accordance with a first embodiment, the substrate is formed from a glass having the following composition, in weight percentages:

| | |
|---|---|
| SiO₂ | 67.0-73.0%, preferably 70.0-72.0%; |
| Al₂O₃ | 0-3.0%, preferably 0.4-2.0%; |
| CaO | 7.0-13.0%, preferably 8.0-11.0%; |
| MgO | 0-6.0%, preferably 3.0-5.0%; |
| Na₂O | 12.0-16.0%, preferably 13.0-15.0%; |
| K₂O | 0-4.0%; |
| TiO₂ | 0-0.1%; |
| total iron (expressed as Fe₂O₃) | 0-0.03%, preferably 0.005-0.01%; |
| redox (FeO/total iron) | 0.02-0.4, preferably 0.02-0.2; |
| Sb₂O₃ | 0-0.3%; |
| CeO₂ | 0-1.5%; and |
| SO₃ | 0-0.8%, preferably 0.2-0.6%. |

The glass substrate according to this embodiment has, after the silver ion exchange, at the pattern or patterns, a variation in the refractive index greater than or equal to 0.05, preferably greater than or equal to 0.08. The refractive index is identical over the entire thickness of the glass where the ion exchange is carried out.

In accordance with a second embodiment, the substrate is formed from a glass having the following composition, in weight percentages:

| | |
|---|---|
| SiO₂ | 60.0-72.0%, preferably 64.0-70.0%; |
| Al₂O₃ | 15.0-25.0%, preferably 18.0-21.0%; |
| CaO | 0-5%, preferably 0-1.0%; |
| MgO | 0-5%, preferably 1.0-3.0%; |
| ZnO | 0-5%, preferably 1.0-3.0%; |
| BaO | 0-5%, preferably 0-1.0%; |
| TiO₂ | 0-5%, preferably 0-3.0%; |
| ZrO₂ | 0-5%, preferably 1.0-4.0%; |
| Li₂O | 2.0-8.0%, preferably 3.0-5.0%; |
| Na₂O | 0-6%, preferably 0-5.0%, |
| | advantageously 0-3.0%; |
| K₂O | 0-5%, preferably 0-3.0%; |
| total iron (expressed as Fe₂O₃) | 0-0.1%, preferably 0-0.08%; |
| redox | 0.02-0.6, preferably 0.02-0.4; |
| As₂O₃ | 0-1.0%; |
| ZnS | 0-1.0%; |
| SnO₂ | 0-1.0%; and |
| impurities (HfO₂, Cr₂O₃ and/or | <0.5%. |
| P₂O₃) | |

Advantageously, the sum of the contents of Li₂O, Na₂O and K₂O varies from 3 to 10%. A total content of these oxides below 6% makes it possible to obtain a substrate that has a low thermal expansion coefficient α₂₅₋₃₀₀, in particular between 40 and 60×10⁻⁷ K⁻¹, whereas a content greater than 6% has the effect of increasing the variation in the refractive index beyond 0.06.

The glass substrate according to this second embodiment has, after the silver ion exchange, a thermal expansion coefficient α₂₅₋₃₀₀ below 60×10⁻⁷ K⁻¹, preferably between 30 and 45×10⁻⁷ K⁻¹.

In accordance with a third embodiment, the substrate is formed from a glass having the following composition, in weight percentages:

| | |
|---|---|
| SiO₂ | 60.0-80.0%, preferably 66.0-80.0%; |
| Al₂O₃ | 0-8%, preferably 1.5-8%; |
| B₂O₃ | 6.0-16.0%, preferably 10.0-14.0% |
| CaO | 0-2.0%, preferably less than 0.5%; |
| ZnO | 0-1%; |
| BaO | 0-4%; |
| MgO | 0-2.0%, preferably less than 0.5%; |
| Na₂O | 6.0-10.0%, preferably 6.0-8.0%; |
| K₂O | 0-4.0%, preferably 0-2.0%; |
| Li₂O | 0-1.0%, preferably 0%; |
| TiO₂ | 0-2.0%, preferably less than 0.5%; |
| total iron (expressed as Fe₂O₃) | 0-0.1%, preferably 0-0.08%; |
| redox (FeO/total iron) | 0.02-0.6, preferably 0.02-0.4; |
| MnO | 0-0.1%, preferably 0-0.05%; and |
| SO₃ | less than 0.2%. |

The glass substrate according to this third embodiment has, after the silver ion exchange, a thermal expansion coefficient α₂₅₋₃₀₀ below 60×10⁻⁷ K⁻¹, preferably between 30 and 45×10⁻⁷ K⁻¹.

Advantageously, the glass substrate according to the invention has, at the ion pattern or patterns, a light transmission coefficient TL₄₁₀ greater than or equal to 80%, which corresponds to a slight yellow coloration.

Preferably, the substrate according to the invention has an exchange depth greater than or equal to 200 μm.

The process for manufacturing the glass substrate comprising one or more ion patterns also forms one subject of the present invention.

This process comprises the steps consisting in:

a) bringing the glass substrate into contact with an outside source of silver ions;

b) subjecting the whole assembly to a temperature that varies from 200 to 400° C., preferably 250 to 350° C., in the presence of an electric field for sufficient time to at least partially replace the alkali metal ions with silver ions; and

c) optionally subjecting the substrate to a heat treatment in order to diffuse the silver ions laterally in the glass.

In step a) the outside source of silver ions may be a bath of one or more known molten silver salts, for example a chloride or a nitrate. The source of silver ions is applied to one side of the substrate in a pattern or an array of patterns of predefined shape. The pattern may be obtained by means of the source of silver ions, which then has a geometry suitable for supplying the desired pattern, or by forming on the surface of the glass a diffusion mask capable of withstanding the ion-exchange treatment and that has appropriate openings for obtaining the shape of the pattern. The mask may be, for example, a mechanical mask made according to the known techniques of lithography and/or of etching, for example a dielectric, conductive or resin mask, or else an ion mask having a pattern complementary to the desired pattern(s) that is formed by diffusion from an ionic species having a lower mobility than the mobility of the silver ions.

The side opposite the first side of the substrate in contact with the silver ions is brought into contact with a bath of molten salts of a second ionic species that allows the diffusion of the alkali metal ions coming from the glass, for example sodium nitrate and/or potassium nitrate. Preferably, a mixture having equal parts of sodium nitrate and potassium nitrate is used.

The outside source of silver ions may also be formed from a solid layer based on metallic silver (Ag°) or ionic silver (Ag⁺) deposed on one side of the substrate in the desired pattern or array of patterns. The solid layer may be deposited by known methods, for example by screen-printing of a paste based on metallic silver or of a paste comprising a silver salt, especially a silver chloride, nitrate or sulfate, and a polymer, by sputtering metallic silver or by depositing a solution comprising a silver salt, especially a silver chloride, nitrate or sulfate, and a polymer, followed by a treatment that aims to evaporate the liquid phase.

When the single silver pattern has a sufficient size or when the silver patterns form a continuous array, said pattern or said array acts as an electrode and may thus be connected directly to the voltage generator so that the ion exchange can take place during the following step b).

In the opposite case, namely when the single pattern is of small size or when the patterns are discrete (that is to say, not joined to one another), it is necessary to apply an electrode to said pattern(s). This electrode may be solid or apertured and may have a variable shape and size suitable for the silver patterns.

In either case, the side of the substrate opposite the side coated with the silver pattern or patterns is provided with an electrode capable of accepting the alkali metal ions extracted from the glass during the exchange.

In step b), an electric field is applied between the baths or the electrodes in contact respectively with the first and second sides of the substrate, which makes it possible to increase the rate of diffusion of the silver ions into the glass and therefore to reduce the ion-exchange time.

The electric field may vary to a large extent depending on the conductivity of the glass substrate used and on its thickness, for example from 0.1 to 1000 V/mm of glass thickness, preferably from 1 to 200 V/mm.

The additional heat treatment applied, where necessary, in step b) aims to rediffuse the ions in the ion pattern in a plane parallel to the first side of the substrate. This treatment is carried out under known temperature conditions, for example 300 to 400° C.

The glass substrate according to the invention may be used, in particular, for forming gradient-index lenses.

The following examples make it possible to illustrate the invention without however limiting the scope thereof.

### EXAMPLE 1

A substrate was formed from the glass composition comprising the constituents below, in the following contents expressed as weight percentages:

| | |
|---|---|
| SiO₂ | 71.6%; |
| Al₂O₃ | 0.8%; |
| CaO | 8.8%; |
| MgO | 3.8%; |
| Na₂O | 14.0%; |
| Sb₂O₃ | 0.2%; |
| SO₃ | 0.1%; |
| total iron (expressed as Fe₂O₃) | 0.01%; |
| | and |
| FeO/total iron | 0.1. |

The substrate was a 5 cm-sided square with a thickness of 2.1 mm.

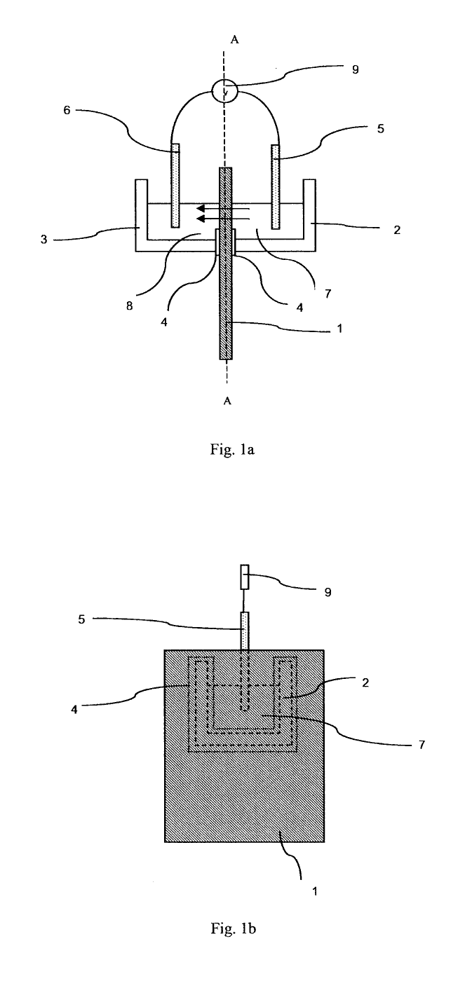

The substrate was subjected to an ion-exchange treatment in the device represented in FIG. 1a (transverse section) and 1b (longitudinal section along the AA axis). The device comprised the substrate 1 equipped with two compartments 2 and 3, forming reservoirs, applied opposite one another. The compartments 2 and 3 were attached to the substrate using an adhesive 4 which also acted as a seal with respect to the contents of the reservoir. The compartments 2 and 3 were each equipped with a platinum electrode 5 and 6 connected to a voltage generator 9.

Compartment 2 contained a bath 7 of AgNO₃ and compartment 3 was filled with a (1/1; wt/wt) KNO₃/NaNO₃ mixture. When an electric field was applied between the electrodes 5 and 6, the alkali metal ions of the glass were moved to the bath 8 and were gradually replaced with the Ag⁺ ions contained in the bath 7 (direction of migration indicated by the arrows).

The ion exchange was carried out at a temperature of 300° C. for 4 hours while applying an electric field of 38.1 V/mm of glass thickness.

The following were measured on the substrate: the depth of diffusion of the Ag⁺ ions into the glass at the exchange zone, the refractive index at 500 nm (n₅₀₀) and the light transmission at 410 nm (TL₄₁₀), before and after the ion-exchange treatment.

The values were the following:
diffusion depth: 140 μm
n₅₀₀
   before: 1.526
   after: 1.630
TL₄₁₀
   before: 90.5%
   after: 81.0%

### EXAMPLE 2

A substrate was formed under the conditions from example 1, but modified in that the glass composition had the composition given below, in weight percentages, in that the substrate had a thickness equal to 3.9 mm and in that the electric field applied was equal to 2 V/mm of glass thickness.

| | |
|---|---|
| SiO₂ | 68.7%; |
| Al₂O₃ | 18.9%; |
| MgO | 1.2%; |
| Li₂O | 3.4%; |
| total iron (expressed as Fe₂O₃) | 0.07%; |
| TiO₂ | 2.6%; |
| BaO | 0.8%; |
| ZrO₂ | 1.7%; |
| ZnO | 1.6%; |
| Na₂O | 0.1%; |
| K₂O | 0.1%; |
| | and |
| As₂O₃ | 0.5%. |

The substrate had the following properties:
diffusion depth: 220 μm
n₅₀₀
   before: 1.527
   after: 1.565
TL₄₁₀
   before: 84.6%
   after: 84.3%

### EXAMPLE 3

A substrate was formed under the conditions from example 1, but modified in that the glass composition had the composition given below, in weight percentages, in that the substrate had a thickness equal to 2 mm, in that the electric field applied was equal to 100 V/mm of glass thickness and in that the ion-exchange time was equal to 6 hours.

| | |
|---|---|
| SiO₂ | 78.00%; |
| Al₂O₃ | 2.00%; |
| B₂O₃ | 12.9%; |
| Na₂O | 6.7%; |
| CaO | 0.1%; |
| TiO₂ | 0.015%; |
| total iron (expressed as Fe₂O₃) | 0.04%; |
| MnO | 0.05%; |
| | and |
| SO₃ | <0.01%. |

The substrate had the following properties:
diffusion depth: 220 μm
n₅₀₀
   before: 1.489
   after: 1.531
TL₄₁₀
   before: 89.5%
   after: 86.8%

### COMPARATIVE EXAMPLE 1

A substrate was formed under the conditions from example 1, but modified in that the glass composition had the composition given below, in weight percentages:

| | |
|---|---|
| SiO₂ | 71.1%; |
| Al₂O₃ | 0.6%; |
| Na₂O | 13.8%; |
| K₂O | 0.2%; |
| CaO | 8.7%; |
| MgO | 4.0%; |
| total iron (expressed as Fe₂O₃) | 0.08%; |
| | and |
| FeO/total iron | 0.25. |

The substrate had the following properties:
diffusion depth: 130 μm
n₅₀₀
   before: 1.514
   after: 1.619
TL₄₁₀
   before: 80.0%
   after: 31.5%

### COMPARATIVE EXAMPLE 2

A substrate was formed under the conditions from example 1, but modified in that the glass composition had the composition given below, in weight percentages, in that the glass thickness was equal to 4 mm, the electric field applied was equal to 75 V/mm of glass thickness and in that the ion-exchange time was equal to 19 hours.

| | |
|---|---|
| SiO₂ | 83%; |
| Al₂O₃ | 2%; |
| Na₂O | 4%; |
| K₂O | 0.6%; |
| | and |
| B₂O₃ | 12%. |

The substrate had the following properties:
diffusion depth: 220 μm
n₅₀₀
   before: 1.480
   after: 1.495
TL₄₁₀
   before: 90.0%
   after: 86.5%

It was observed that the glass compositions from examples 1, 2 and 3 according to the invention made it possible to have a variation in the refractive index at least equal to 0.038 over a depth of at least 140 μm without significant reduction in the light transmission measured at 410 nm, that is to say without the appearance of an undesirable yellow coloration.

On the contrary, comparative example 1 revealed a high level of yellowing, expressed by a low value of TL₄₁₀, equal to 34.5%, and comparative example 2 had a low variation in the refractive index, equal to 0.015.

### EXAMPLES 4 TO 6

Substrates were formed under the conditions from example 1, having the composition given in table 1, expressed in weight percentages.

Examples 4 and 5 were in accordance with the invention and example 6 was a comparative example having a high total iron content.

The substrates had a thickness of 2 mm.

The ion exchange conditions and the properties of the substrates are collated in table 1.

### EXAMPLES 7 AND 8

Substrates were formed under the conditions from example 1, having the composition given in table 2, expressed in weight percentages.

The substrates had a thickness of 2 mm.

The ion exchange conditions and the properties of the substrates are collated in table 2.

### EXAMPLE 9

A substrate was formed under the conditions from example 1, but modified in that the glass composition had the composition given below, in weight percentages, in that the substrate had a thickness equal to 2 mm, in that the electric field applied was equal to 60 V/mm of glass thickness and in that the ion-exchange time was equal to 5 hours.

| | |
|---|---|
| SiO₂ | 78.5%; |
| Al₂O₃ | 2.1%; |
| B₂O₃ | 12.4%; |
| CaO | 0.02% |
| BaO | 0.02%; |
| Na₂O | 6.5%; |
| K₂O | 0.01%; |
| Li₂O | 0.4%; |
| TiO₂ | 0.03%; |
| total iron (expressed as Fe₂O₃) | 0.02%; |
| | and |
| FeO/total iron | 0.20. |

The substrate had the following properties:
diffusion depth: 100 μm
n₅₀₀
   before: 1.485
   after: 1.524
TL₄₁₀
   before: 90.7%
   after: 87.0%

TABLE 1

| | | | Ex. 6 |
|---|---|---|---|
| | Ex. 4 | Ex. 5 | (comp.) |
| Composition (weight %) | | | |
| SiO₂ | 72.0 | 70.7 | 72.0 |
| Al₂O₃ | 0.8 | 2.4 | 0.8 |
| CaO | 9.0 | 8.9 | 9.0 |
| MgO | 3.9 | 3.8 | 3.8 |
| Na₂O | 14.0 | 14.0 | 14.1 |
| SO₃ | 0.2 | 0.2 | 0.2 |
| Total iron (expressed | 0.01 | 0.01 | 0.09 |
| as Fe₂O₃) | | | |
| FeO/total iron | 0.20 | 0.10 | 0.17 |
| Exchange conditions | | | |
| Electric field (V/mm) | 20 | 20 | 20 |
| Temperature (° C.) | 310 | 310 | 300 |
| Time (hours) | 4.0 | 4.0 | 3.5 |
| Properties | | | |
| Diffusion depth (μm) | 100 | 100 | 70 |
| n₅₀₀ | | | |
| before | 1.527 | 1.527 | 1.514 |
| after | 1.630 | 1.630 | 1.619 |
| TL₄₁₀ (%) | | | |
| before | 91.3 | 90.9 | 89.1 |
| after | 82.1 | 79.8 | 59.8 |

TABLE 2

| | Ex. 7 | Ex. 8 |
|---|---|---|
| Composition (weight %) | | |
| SiO₂ | 68.4 | 66.1 |
| Al₂O₃ | 19.9 | 19.3 |
| CaO | 0.03 | 0.06 |
| MgO | 1.10 | 1.00 |
| ZnO | 1.5 | 1.7 |
| TiO₂ | 0.01 | 2.70 |
| ZrO₂ | 1.4 | 1.9 |
| Li₂O | 2.3 | 2.2 |
| Na₂O | 5.3 | 4.9 |
| K₂O | — | 0.02 |
| Total iron (expressed as Fe₂O₃) | 0.01 | 0.02 |
| FeO/total iron | 0.30 | 0.23 |
| Exchange conditions | | |
| Electric field (V/mm) | 1.5 | 0 |
| Temperature (° C.) | 300 | 315 |
| Time (hours) | 5.5 | 76 |
| Properties | | |
| Diffusion depth (μm) | 150 | 310 |
| n₅₀₀ | | |
| before | 1.518 | 1.530 |
| after | 1.570 | 1.587 |
| TL₄₁₀ (%) | | |
| before | 90.6 | 84.3 |
| after | 88.3 | 80.9 |

1. A glass substrate comprising at least one ion pattern obtained by a treatment comprising exchanging alkali metal ions of a glass with silver ions originating from an outside source, wherein said substrate is formed from a glass having following composition, in weight percentages:

| | |
|---|---|
| SiO₂ | 67.0-73.0%; |
| Al₂O₃ | 0-3.0%; |
| CaO | 7.0-13.0%; |
| MgO | 0-6.0%; |
| Na₂O | 12.0-16.0%; |
| K₂O | 0-4.0%; |
| TiO₂ | 0-0.1%; |
| total iron (expressed by Fe₂O₃) | 0-0.03%; |
| redox (FeO/total iron) | 0.02-0.4; |
| Sb₂O₃ | 0-0.3%; |
| CeO₂ | 0-1.5%; |
| | and |
| SO₃ | 0-0.8%, |

and wherein said ion pattern has a variation in a refractive index greater than or equal to 0.03, a depth greater than or equal to 100 μm and a light transmission coefficient at 410 nm (TL₄₁₀) greater than or equal to 60%.

2. The substrate according to claim 1, wherein the variation in the refractive index is greater than or equal to 0.05.

3. The substrate according to claim 1, wherein the light transmission coefficient TL₄₁₀ is greater than or equal to 80%.

4. The substrate according to claim 1, wherein the depth is greater than or equal to 200 μm.

5. A glass substrate comprising at least one ion pattern obtained by a treatment comprising exchanging alkali metal ions of a glass with silver ions originating from an outside source, wherein said substrate is formed from a glass having following composition, in weight percentages:

| | |
|---|---|
| SiO₂ | 60.0-72.0%; |
| Al₂O₃ | 15.0-25.0%; |
| CaO | 0-5%; |
| MgO | 0-5%; |
| ZnO | 0-5%; |
| BaO | 0-5%; |
| TiO₂ | 0-5%; |
| ZrO₂ | 0-5%; |
| Li₂O | 2.0-8.0%; |
| Na₂O | 0-6%, |
| K₂O | 0-5%; |
| total iron (expressed by Fe₂O₃) | 0-0.1%; |
| Redox | 0.02-0.6; |
| As₂O₃ | 0-1.0%; |
| ZnS | 0-1.0%; |
| SnO₂ | 0-1.0%; |
| | and |

impurities comprising one or more of HfO₂, Cr₂O₃ and P₂O₃<0.5%,
and wherein said ion pattern has a variation in the refractive index greater than or equal to 0.03, a depth greater than or equal to 100 μm and a light transmission coefficient at 410 nm (TL₄₁₀) greater than or equal to 60%.

6. The glass substrate according to claim 5, wherein a sum of the contents of Li₂O, Na₂O and K₂O varies from 3 to 10%.

7. The substrate according to claim 5, wherein the substrate has a thermal expansion coefficient α₂₅₋₃₀₀ below 60×10⁻⁷ K⁻¹.

8. The substrate according to claim 5, wherein the light transmission coefficient TL₄₁₀ is greater than or equal to 80%.

9. The substrate according to claim 5, wherein the depth is greater than or equal to 200 μm.

10. A glass substrate comprising at least one ion pattern obtained by a treatment comprising exchanging alkali metal ions of a glass with silver ions originating from an outside source, wherein said substrate is formed from a glass having the following composition, in weight percentages:

| | |
|---|---|
| SiO₂ | 60.0-80.0%; |
| Al₂O₃ | 0-8%; |
| B₂O₃ | 6.0-16.0%; |
| CaO | 0-2.0%; |
| ZnO | 0-1%; |
| BaO | 0-4%; |
| MgO | 0-2.0%; |
| Na₂O | 6.0-10.0%; |
| K₂O | 0-4.0%; |
| Li₂O | 0-1.0%; |
| TiO₂ | 0-2.0%; |
| total iron (expressed by Fe₂O₃) | 0-0.1%; |
| redox (FeO/total iron) | 0.02-0.6; |
| MnO | 0-0.1%; |
| | and |
| SO₃ | less than 0.2%, |

and wherein said ion pattern has a variation in the refractive index greater than or equal to 0.03, a depth greater than or equal to 100 μm and a light transmission coefficient at 410 nm (TL₄₁₀) greater than or equal to 60%.

11. The substrate according to claim 10, wherein the substrate has a thermal expansion coefficient α₂₅₋₃₀₀ below 60×10⁻⁷ K⁻¹.

12. The substrate according to claim 10, wherein the light transmission coefficient TL₄₁₀ is greater than or equal to 80%.

13. The substrate according to claim 10, wherein the depth is greater than or equal to 200 μm.

14. A process for manufacturing the glass substrate according to claim 1, comprising:
a) bringing the glass substrate into contact with an outside source of silver ions;
b) subjecting a whole assembly comprising the glass substrate to a temperature that varies from 200 to 400° C., in the presence of an electric field for sufficient time to at least partially replace alkali metal ions with silver ions; and
c) optionally subjecting the substrate to a heat treatment in order to diffuse the silver ions laterally in the glass.

15. The process according to claim 14, wherein the electric field varies from 0.1 to 1000 V/mm of glass thickness.

16. The process according to claim 14, wherein the outside source of silver ions is a bath of one or more molten silver salts.

17. The process according to claim 14, wherein the source of silver ions is a solid layer based on metallic silver.
